(19) United States
(12) Patent Application Publication
(10) Pub. No.: US 2021/0103870 A1
(43) Pub. Date: Apr. 8, 2021

(54) COST PRESENTATION APPARATUS, COST PRESENTATION METHOD, COMPUTER-READABLE STORAGE MEDIUM

(71) Applicant: Hitachi, Ltd., Tokyo (JP)

(72) Inventors: Shinichi HAYASHI, Tokyo (JP); Satoshi KANEKO, Tokyo (JP); Tomohiro MORIMURA, Tokyo (JP); Hiroyoshi JUTORI, Tokyo (JP)

(73) Assignee: Hitachi, Ltd.

(21) Appl. No.: 17/016,052

(22) Filed: Sep. 9, 2020

(30) Foreign Application Priority Data
Oct. 4, 2019 (JP) 2019-183412

(51) Int. Cl. G06Q 10/06; H04L 12/24; H04L 29/08

(52) U.S. Cl. CPC G06Q 10/06313; G06Q 10/06375; H04L 67/34; H04L 41/04

(57) ABSTRACT

When migrating an IT system between clouds, a cost presentation apparatus calculates costs of a VM and a virtual disk in each configuration obtained by combining a VM type, a migration destination cloud, a VM deployment destination, and a virtual disk deployment destination and displays a relationship between the cost of the VM and the virtual disk in each of the configurations and activation time (VM uptime) of the VMs and displays, on a GUI, the activation time of the VM in the configuration.

### CROSS-REFERENCE TO RELATED APPLICATIONS

This application is based upon and claims the benefit of priority from Japanese Patent Application No. 2019-183412 filed in Japan Patent Office on Oct. 4, 2019, the contents of which are hereby incorporated by reference.

### BACKGROUND

The present disclosure relates to a technique for presenting a cost incurring when an IT system is migrated between clouds.

Companies using private clouds, which are constructed and used within the companies, increasingly use public clouds to reduce costs. The public clouds are used by an unspecified large number of companies and allow the companies to use as many computing resources as needed, when necessary. However, there are cases where using the private clouds costs less than using the public clouds, and it is difficult for the companies to decide on which public cloud to migrate to and what the costs of the migration would be like through making estimations of the costs for thousands of applications, one by one, that the company operates and eventually determining whether or not to execute the migration.

To facilitate such a decision-making process, for example, a technique disclosed in Patent literature 1 is known. Patent literature 1 discloses a technique for presenting simulated costs and performance expected when migration to each cloud is executed.

Patent literature 1: U.S. Patent Application Publication No. 2015/0019301

### SUMMARY

There are cases where costs can be reduced more by optimizing resource amounts allocated to the individual applications than cases where the applications are migrated between clouds. In addition, there are different charging methods for public clouds such as a method for charging the amount based on hours (usage time) that the public cloud is used and a method for charging, on condition of a long-term contract, a fixed amount regardless of the usage time. Therefore, a method that reduces the costs when the cloud-to-cloud migration is executed has to be considered.

There are cases in which operating time (activation time) of a virtual machine (hereinafter, referred to as a VM), on which an application operates, changes and consequently, the usage time thereof changes. Furthermore, there are cases in which an application operates on a plurality of VMs, and a plurality of virtual disks are used to store data of the VMs. There are VMs and virtual disks that are less expensive when deployed on the private cloud, and there are VMs and virtual disks that are less expensive when deployed on the public cloud.

As described above, there are various methods for arranging the VM, on which the application operates, and the virtual disk that stores data. However, there has been provided no technique for properly presenting the cost incurring when the IT system is migrated between clouds.

An object of the present disclosure is to provide a technique for properly presenting a cost incurring when an IT system is migrated between clouds.

A cost presentation apparatus according to one aspect of the present disclosure estimates a relationship between a cost of an infrastructure resource incurring after an IT (Information Technology) system has been migrated between clouds and activation time of the infrastructure resource, estimates the activation time of the infrastructure resource, and presents a result of the estimation of the relationship between the cost of the infrastructure resource and the activation time of the infrastructure resource, and of the estimation of the activation time of the infrastructure resource.

According to one aspect of the present disclosure, a cost incurring when an IT system is migrated between clouds can be properly presented.

### BRIEF DESCRIPTION OF THE DRAWINGS

FIG. 1 illustrates an example of a display screen presented by a cost presentation apparatus according to an embodiment;

FIG. 2 illustrates another example of a display screen presented by the cost presentation apparatus according to the embodiment;

FIG. 3 is a block diagram illustrating a system configuration to which the cost presentation apparatus according to the embodiment is applied;

FIG. 4 illustrates an example of information held in configuration information database in FIG. 3;

FIG. 5 illustrates an example of information held in a VM management function in FIG. 3;

FIG. 6A illustrates an example of auto scaling configuration information in FIG. 5;

FIG. 6B illustrates an example of VM access information in FIG. 5;

FIG. 7 illustrates an example of information held in a storage management function in FIG. 3;

FIG. 8A illustrates an example of a public cloud list in FIG. 3;

FIG. 8B illustrates an example of public cloud VM price information in FIG. 3;

FIG. 8C illustrates an example of public cloud storage price information in FIG. 3;

FIG. 8D illustrates an example of public cloud network price information in FIG. 3;

FIG. 9A illustrates an example of public cloud VM configuration information in FIG. 3;

FIG. 9B illustrates an example of public cloud virtual disk configuration information in FIG. 3;

FIG. 9C illustrates an example of public cloud VM performance information in FIG. 3;

FIG. 10 illustrates an example of post-optimization information in FIG. 3;

FIG. 11 illustrates an example of a change in CPU usage when auto scaling is applied;

FIG. 12 illustrates an example of a change in CPU usage when a VM size has been optimized;

FIG. 13 is a flowchart illustrating processing performed by a VM size optimization function in FIG. 3;

FIG. 14 is a flowchart illustrating processing performed by a cloud optimization function in FIG. 3;

FIG. 15 is an example of VM migration cost information and virtual disk migration cost information stored in the database in FIG. 3;

FIG. 16 illustrates an example of accumulated cost estimation presented by the cost presentation apparatus according to the embodiment;

FIG. 17 illustrates an example of a breakdown of costs presented by the cost presentation apparatus according to the embodiment; and

FIG. 18 is a block diagram illustrating a hardware configuration example of the cost presentation apparatus according to the embodiment.

### DETAILED DESCRIPTION OF THE EMBODIMENT

An embodiment will be described with reference to the drawings. The embodiment described below is not intended to be limiting, and not all elements described in the embodiment and combinations thereof are necessarily essential.

In the following description, when an operation subject is denoted as “a function of”, it is assumed that a processor reads a corresponding function, which is a program, loads the program into a DRAM (Dynamic Random Access Memory), and realizes the function.

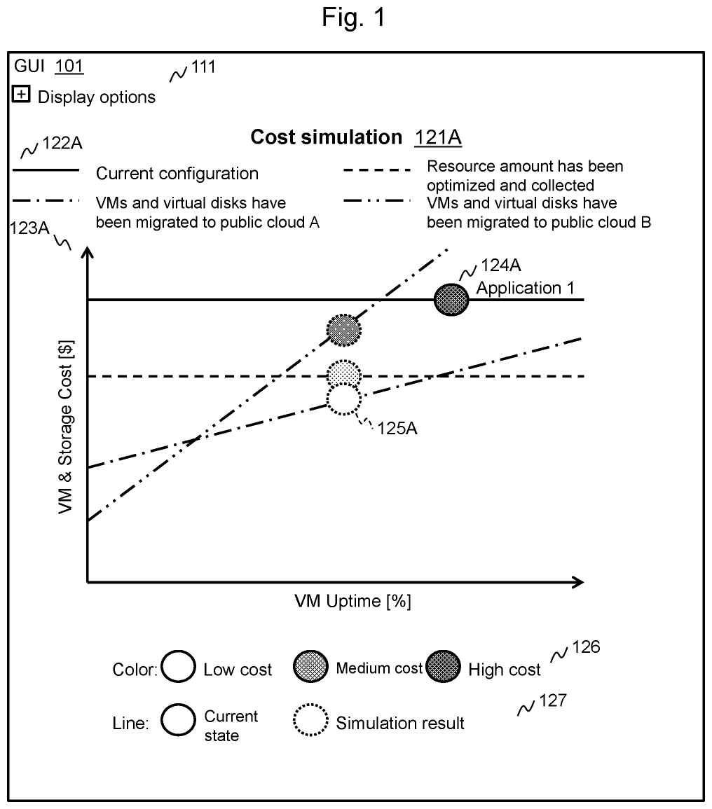

FIG. 1 is an example of a display screen presented by a cost presentation apparatus according to the embodiment.

In FIG. 1, the cost presentation apparatus includes a GUI (Graphical User Interface) 101. When an IT (Information Technology) system is migrated between clouds, the cost presentation apparatus calculates a cost of VMs and virtual disks in each configuration obtained by combining a VM type, a migration destination cloud, a VM deployment destination, and a virtual disk deployment destination. The IT system is, for example, an operating environment of applications. The cost presentation apparatus displays a relationship between the cost of the VMs and the virtual disks in each of the configurations and activation time (also referred to as uptime) of the VMs as well as the activation time of the VMs in the configuration, on the GUI 101. The activation time is time during which the VMs are in operation. The relationship between the cost of the VMs and the virtual disks in each of the configurations and the activation time of the VMs can indicate a reason of the cost reduction effect on the costs of the VMs and the virtual disks per configuration. Thus, a user can grasp the cost reduction effect on the costs of the VMs and the virtual disks per configuration and the corresponding reason at a glance by viewing the GUI 101.

Specifically, the cost presentation apparatus displays an option display button 111 and a graph 121A on the GUI 101. The cost presentation apparatus can display the option display button 111 and the graph 121A on the GUI 101 per application used in the IT system.

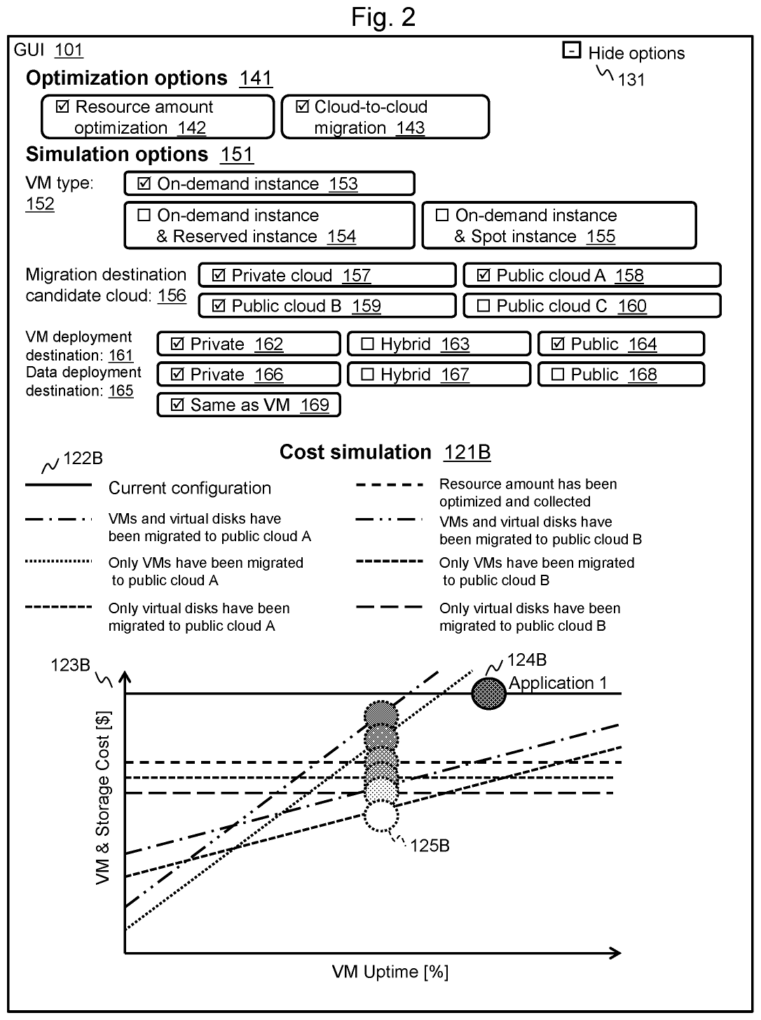

When the option display button 111 is clicked, the cost presentation apparatus displays options on the GUI 101 as illustrated in FIG. 2. The option can select a configuration to be displayed on the GUI 101 from among various configurations in each of which the VM type, the migration destination cloud, the VM deployment destination, and the virtual disk deployment destination are combined.

The graph 121A indicates results of cost simulation performed on VMs and storage after the configuration has been changed. The graph 121A includes legends 122A for polygonal lines, a line graph 123A, circles 124A and 125A, legends 126 for circle colors, and legends 127 for circle lines. Each of the legends 122A for the polygonal lines indicates a configuration at the time when the cost is calculated.

The configuration at the time when the cost is calculated can be a configuration obtained by arbitrarily combining the VM type, the migration destination cloud, the VM deployment destination, and the virtual disk deployment destination. The line graph 123A indicates a relationship between a cost of the VMs and the storage and VM uptime. The VM uptime indicates a ratio of time during which the VMs are in operation in an analysis time period. The analysis time period is, for example, one month.

The circle 124A indicates current average uptime of the VMs used by application 1 and a current cost of the VMs and the storage used by the application 1. The circle 125A indicates average uptime of the VMs used by the application 1 after the configuration thereof is changed and a cost of the VMs and the storage used by the application 1 after the configuration thereof is changed. The legends 126 of circle colors indicate a relationship between the circle colors and the levels of the cost. The legends 127 of circle lines indicate whether the circle represents a value of the current configuration or a simulation result.

By referring to the graph 121A, the user can grasp that, in terms of the application 1, migrating the VMs and the virtual disks to public cloud B reduces the cost, compared with the current configuration, and the user can also grasp at a glance that this cost reduction effect is caused by the effect of shortening the VM uptime. In addition, by referring to the graph 121A, the user can grasp that, in terms of the application 1, migrating the VMs and the virtual disks to the public cloud B reduces more cost, compared with migrating the VMs and the virtual disks to the public cloud A.

FIG. 2 illustrates another example of the display screen presented by the cost presentation apparatus according to the embodiment.

In FIG. 2, when the option display button 111 in FIG. 1 is clicked, the cost presentation apparatus displays an optimization option 141 and a simulation option 151 on the GUI 101. The user can select options from the optimization option 141 and the simulation option 151. The cost presentation apparatus displays a simulation result that is calculated based on the selected options on a graph 121B. The graph 121B indicates a cost simulation result of the VMs and the storage after the configuration has been changed based on the selected options.

The graph 121B includes legends 122B of polygonal lines, a line graph 123B, and circles 124B and 125B. Each of the legends 122B of the polygonal lines indicates a configuration at the time when the cost is calculated based on the selected options. The line graph 123B indicates a relationship between the cost of the VMs and the storage configured based on the selected options and the VM uptime.

The circle 124B indicates current average uptime of the VMs used by the application 1 and a current cost of the VMs and the storage used by the application 1. The circle 125B indicates average uptime of the VMs used by the application 1 after the configuration thereof is changed and a cost of the VMs and the storage used by the application 1 after the configuration thereof is changed, in the configuration based on the selected options.

The optimization option 141 includes buttons 142 and 143. When the button 142 is checked, the cost presentation apparatus displays, on the GUI 101, the cost incurring in a case in which the amounts of resources for the VMs and the storage are optimized and unnecessary VMs are collected. When the button 143 is checked, the cost presentation apparatus displays the cost including a case in which a cloud-to-cloud migration is performed on the GUI 101.

The simulation option 151 includes a VM type 152, a migration destination candidate cloud 156, a VM deployment destination 161, and a data deployment destination 165.

The VM type 152 is an option that specifies a type of VM used when the public cloud is used. The VM type 152 includes buttons 153 to 155. When the button 152 is checked, the cost presentation apparatus displays the cost incurring in a case in which all the VMs are on-demand instances on the GUI 101. When the button 153 is checked, the cost presentation apparatus displays the cost incurring in a case in which on-demand instances and reserved instances are used on the GUI 101. When the button 154 is checked, the cost presentation apparatus displays the cost incurring in a case in which on-demand instances and spot instanced are used on the GUI 101.

The migration destination candidate cloud 156 is an option that specifies a cloud to be used as a migration destination. The migration destination candidate cloud 156 includes buttons 157 to 160. When the button 157 is checked, the cost presentation apparatus displays the cost incurring in a case in which the private cloud is included as a migration destination on the GUI 101. When each of the buttons 158 to 160 is checked, the cost presentation apparatus displays the cost incurring in a case in which a corresponding one of the public clouds A to C is included as a migration destination on the GUI 101. The public cloud includes both the private cloud and the public cloud.

The VM deployment destination 161 is an option that specifies a cloud on which the VMs are deployed. The VM deployment destination 161 includes buttons 162 to 164. When the button 162 is checked, the cost presentation apparatus displays the cost incurring in a case in which all the VMs are deployed on the private cloud on the GUI 101. When the button 163 is checked, the cost presentation apparatus displays the cost incurring in a case in which the VMs are deployed on the private cloud and the public cloud on the GUI 101. When the button 164 is checked, the cost presentation apparatus displays the cost incurring in a case in which all the VMs are deployed on the public cloud on the GUI 101.

The data deployment destination 165 is an option that specified a cloud on which the virtual disks are deployed. The data deployment destination 165 includes buttons 166 to 169. When the button 166 is checked, the cost presentation apparatus displays the cost incurring in a case in which all the virtual disks are deployed on the private cloud on the GUI 101. When the button 167 is checked, the cost presentation apparatus displays the cost incurring in a case in which the virtual disks are deployed on both of the private cloud and the public cloud on the GUI 101. When the button 168 is checked, the cost presentation apparatus displays the cost incurring in a case in which all the virtual disks are deployed on the public cloud on the GUI 101. When the button 169 is checked, the cost presentation apparatus displays the cost incurring in a case in which the virtual disk is deployed on the same cloud as that on which the VM using the virtual disk is deployed on the GUI 101.

FIG. 2 illustrates an example in which a line graph 123B and circles 124B and 125B when the buttons 153, 157, 158, 159, 162, 164, 166, and 169 are checked in the simulation option 151 are displayed on the GUI 101.

In addition, when the option display button 111 in FIG. 1 is clicked, the cost presentation apparatus displays a button 131 for hiding the options on the GUI 101. When the button 131 for hiding the options is clicked, the cost presentation apparatus returns to the screen in FIG. 1.

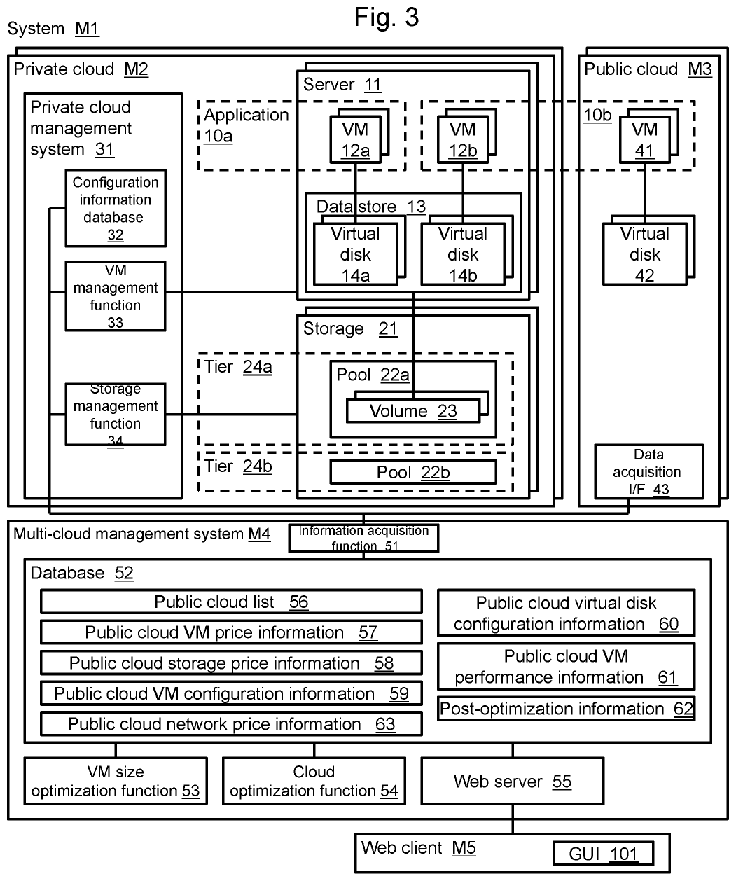

FIG. 3 is a block diagram illustrating a system configuration to which the cost presentation apparatus according to the embodiment is applied.

In FIG. 3, a system M1 includes a plurality of private clouds M2, a plurality of public clouds M3, a multi-cloud management system M4, and a web client M5. The system M1 is, for example, an operation management system or a financial management system. The private clouds M2 are used only by a specific company or organization. The public clouds M3 are used by unspecified number of companies and organizations. The private clouds M2 and the public clouds M3 are used for operating applications. The applications are, for example, software that provides operation management processing or financial management processing. The multi-cloud management system M4 manages the private clouds M2 and the public clouds M3.

The individual private cloud M2 includes a server 11, a storage 21, and a private cloud management system 31. The server 11 is used to operate applications. The storage 21 stores data read or written by the applications. The private cloud management system 31 manages the server 11 and the storage 21.

The server 11 includes VMs 12a and 12b and a data store 13. The data store 13 includes virtual disks 14a and 14b. The VMs 12a and 12b are used to operate the applications. The virtual disks 14a and 14b created in the data store 13 are coupled to the VMs 12a and 12b, respectively, and the individual VMs 12a and 12b store data of the applications in the virtual disks 14a and 14b, respectively.

Data of the data store 13 is stored in the storage 21. Applications 10a and 10b each represent a group of VMs in which a corresponding application operates.

The storage 21 includes pools 22a and 22b. For example, data of the application is stored in a volume 23 created in the pool 22a. Tiers 24a and 24b represent classes of the pools 22a and 22b, respectively. Target performance and the cost are specified for each of the tiers 24a and 24b.

The private cloud management system 31 includes a configuration information database 32, a VM management function 33, and a storage management function 34. The configuration information database 32 stores relationships between the applications and the VMs, relationships between the tiers and the pools, VM price information, and storage price information. The VM management function 33 manages the server 11, the VMs 12a and 12b, and the data store 13. The storage management function 34 manages the storage 21 and the pools 22a and 22b.

The individual public cloud M3 includes a VM 41, a virtual disk 42, and a data acquisition I/F 43. The VM 41 is used to operate an application, as are the VMs 12a and 12b. The virtual disk 42 is coupled to the VM 41, and the VM 41 stores data of the application in the virtual disk 42. The data acquisition I/F 43 is an interface for acquiring configuration information and performance information about the VM 41 and the virtual disk 42.

The multi-cloud management system M4 includes an information acquisition function 51, a database 52, a VM size optimization function 53, a cloud optimization function 54, and a web server 55. The database 52 stores a public cloud list 56, public cloud VM price information 57, public cloud storage price information 58, public cloud VM configuration information 59, public cloud virtual disk configuration information 60, public cloud VM performance information 61, post-optimization information 62, and public cloud network price information 63.

The information acquisition function 51 acquires data managed in the individual private cloud M2 from the configuration information database 32, the VM management function 33, and the storage management function 34, acquires data managed in the individual public cloud M3 from the data acquisition I/F 43, and stores the acquired data in the database 52.

The database 52 stores data acquired from the private clouds M2 and the public clouds M3 and calculation results obtained by the VM size optimization function 53 and the cloud optimization function 54.

If excessive amounts of resources are allocated to the VMs 12a, 12b, and 41, the VM size optimization function 53 calculates appropriate amounts of resources needed for operating the applications and optimizes the amounts of the resources allocated to the VMs 12a, 12b, and 41.

The cloud optimization function 54 calculates the costs of the VMs 12a, 12b, and 41 and the virtual disks 14a, 14b, and 42 that are allocated in the current configuration and the costs of the VMs 12a, 12b, and 41 and the virtual disks 14a, 14b, and 42 that will be allocated if the cloud-to-cloud migration is performed. In this operation, the cloud optimization function 54 calculates the costs of the VMs 12a, 12b, and 41 and the virtual disks 14a, 14b, and 42 for each of the applications 10a and 10b.

In response to a request from the web client M5, the web server 55 reads the results of the calculations performed by the VM size optimization function 53 and the cloud optimization function 54 from the database 52 and transmits the results to the web client M5. As examples of the results of the calculations performed by the VM size optimization function 53 and the cloud optimization function 54, for example, the graph 121A in FIG. 1 and the graph 121B in FIG. 2 can be obtained.

The web client M5 is a client that allows the administrator of the system M1 to manage the system M1. The web client M5 includes the GUI 101. The GUI 101 is an interface for displaying the state of the system M1.

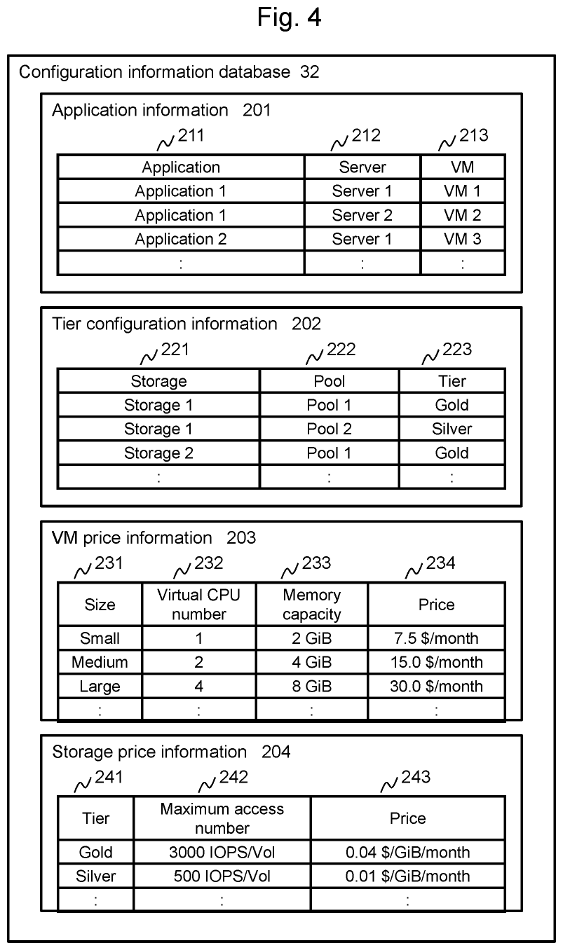

FIG. 4 illustrates an example of information held in the configuration information database in FIG. 3.

In FIG. 4, the configuration information database 32 holds application information 201, tier configuration information 202, VM price information 203, and storage price information 204.

The application information 201 indicates relationships between the applications 10a and 10b and the VMs 12a and 12b in FIG. 3. The application information 201 includes entries under “Application” 211, “Server” 212, and “VM” 213. An entry under “Application” 211 indicates the name of the application 10a or 10b. An entry under “Server” 212 indicates the name of the server 11 in which the VMs 12a and 12b operate. An entry under “VM” 213 indicates the name of the VM 12a or 12b in which the application 10a or 10b operates.

The tier configuration information 202 indicates relationships between the tiers 24a and 24b and the pools 22a and 22b in FIG. 3.

The tier configuration information 202 includes entries under “Storage” 221, “Pool” 222, and “Tier” 223. An entry under “Storage” 221 indicates the name of the storage 21 in which the pools 22a and 22b are deployed. An entry under “Pool” 222 indicates the name of the pool 22a or 22b. An entry under “Tier” 223 indicates the tier 24a or 24b to which the corresponding pool 22a or 22b belongs.

The VM price information 203 indicates costs of using the VMs 12a and 12b in FIG. 3. The VM price information 203 includes entries under “Size” 231, “Virtual CPU number” 232, “Memory capacity” 233, and “Price” 234. An entry under “Size” 231 indicates the size of the VM 12a or 12b. The virtual CPU number, the memory capacity, and the price are defined per size of the VMs 12a and 12b. An entry under “Virtual CPU number” 232 indicates the number of virtual CPUs allocated to the VMs 12a and 12b. The virtual CPU number is defined per size. An entry under “Memory capacity” 233 indicates the memory capacity allocated to the VMs 12a and 12b. The memory capacity is defined per size. An entry under “Price” 234 indicates the cost incurring when the VM 12a or 12b is used. The costs are defined per size.

The storage price information 204 indicates a cost incurring when the volume 23 in FIG. 3 is used. The storage price information 204 includes entries under “Tier” 241, “Maximum access number” 242, and “Price” 243. An entry under “Tier” 241 indicates the tier 24a or 24b to which the corresponding pool 22a or 22b belongs. An entry under “Maximum access number” 242 indicates the maximum access number per volume that is defined for each of the tiers 24a and 24b. An entry under “Price” 243 indicates the cost per capacity that is defined for each of the tiers 24a and 24b.

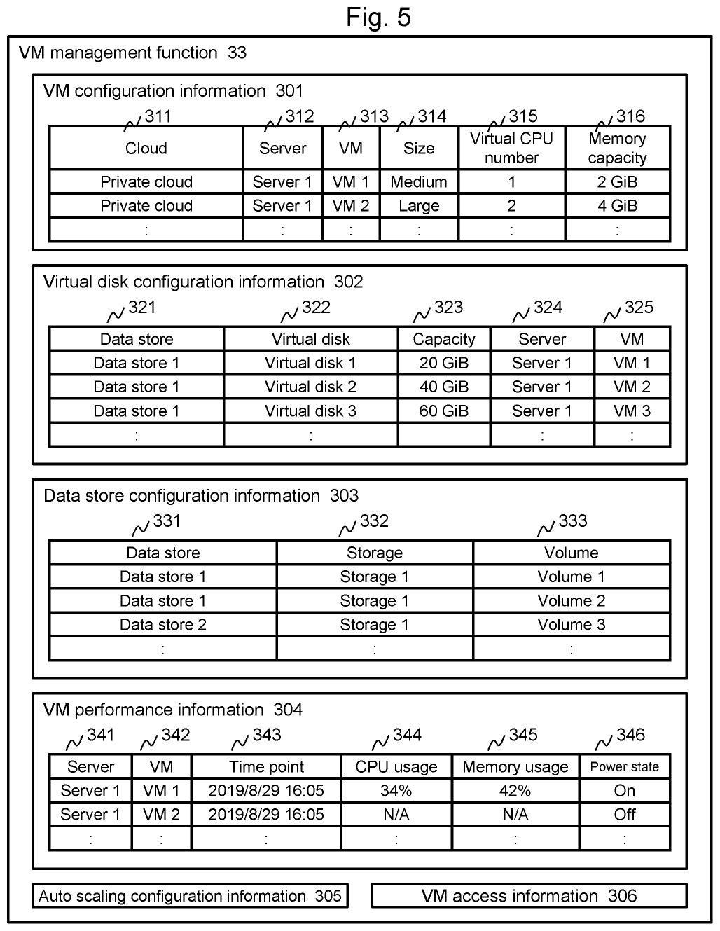

FIG. 5 illustrates examples of information held in the VM management function 33 in FIG. 3.

In FIG. 5, the VM management function 33 holds VM configuration information 301, virtual disk configuration information 302, data store configuration information 303, VM performance information 304, auto scaling configuration information 305, and VM access information 306.

The VM configuration information 301 indicates configurations of the VMs 12a and 12b in FIG. 3.

The VM configuration information 301 includes entries under “Cloud” 311, “Server” 312, “VM” 313, “Size” 314, “Virtual CPU number” 315, and “Memory capacity” 316. An entry under “Cloud” 311 indicates the name of the cloud in which the VM 12a or 12b is deployed. An entry under “Server” 312 indicates the name of the server 11 in which the VMs 12a and 12b are deployed. An entry under “VM” 313 indicates the name of the VM 12a or 12b. An entry under “Size” 314 indicates the size of the VM 12a or 12b. An entry under “Virtual CPU number” 315 indicates the number of virtual CPUs allocated to the VM 12a or 12b. An entry under “Memory capacity” 316 indicates the memory capacity allocated to the VM 12a or 12b.

The virtual disk configuration information 302 indicates configurations of the virtual disks 14a and 14b in FIG. 3. The virtual disk configuration information 302 includes entries under “Data store” 321, “Virtual disk” 322, “Capacity” 323, “Server” 324, and “VM” 325. An entry under “Data store” 321 indicates the name of the data store 13 in which the virtual disks 14a and 14b are deployed. An entry under “Virtual disk” 322 indicates the name of the virtual disk 14a or 14b. An entry under “Capacity” 323 indicates the capacity of the virtual disk 14a or 14b. An entry under “Server” 324 indicates the name of the server 11 in which the VMs 12a and 12b using the virtual disks 14a and 14b are deployed. An entry under “VM” 325 indicates the name of the VM 12a or 12b that uses the virtual disk 14a or 14b.

The data store configuration information 303 indicates a configuration of the data store 13 in FIG. 3. The data store configuration information 303 includes entries under “Data store” 331, “Storage” 332, and “Volume” 333.

The VM performance information 304 holds past performance information about the VMs 12a and 12b in FIG. 3. The VM performance information 304 includes entries under “Server” 341, “VM” 342, “Time point” 343, “CPU usage” 344, “Memory usage” 345, and “Power state” 346. An entry under “Server” 341 indicates the name of the server 11 in which the VMs 12a and 12b operate. An entry under “VM” 342 indicates the name of the VM 12a or 12b. An entry under “Time point” 343 indicates the time point at which each performance information has been recorded. An entry under “CPU usage” 344 indicates the CPU usage of the VM 12a or 12b. An entry under “Memory usage” 345 indicates the memory usage of the VM 12a or 12b. An entry under “Power state” 346 indicates the power state of the VM 12a or 12b. The power state is either “On” or “Off”.

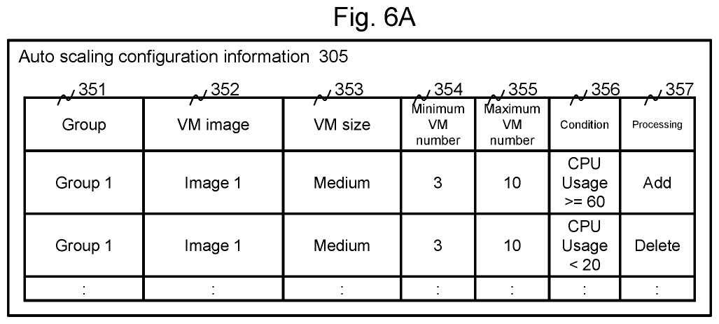

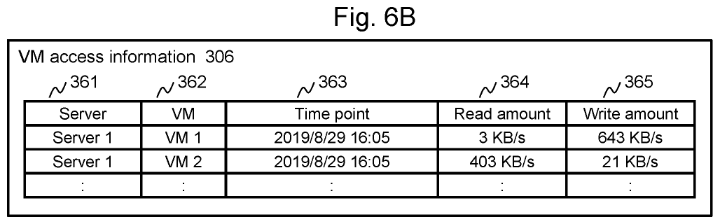

FIG. 6A illustrates an example of auto scaling configuration information in FIG. 5.

In FIG. 6A, when the load of the VM 12a or 12b increases, the auto scaling activates a VM 12a or 12b, and when the load decreases, the auto scaling deactivates the VM 12a or 12b. The auto scaling configuration information 305 includes information about the auto scaling. The auto scaling configuration information 305 includes entries under “Group” 351, “VM image” 352, “VM size” 353, “Minimum VM number” 354, “Maximum VM number” 355, “Condition” 356, and “Processing” 357.

An entry under “Group” 351 indicates the name of a group of the VMs 12a and 12b to be auto-scaled. An entry under “VM image” 352 indicates the VM image used when a VM is activated. An entry under “VM size” 353 indicates the size of a VM 12a or 12b to be activated. An entry under “Minimum VM number” 354 indicates the minimum number of the VMs 12a and 12b that operate in the group. An entry under “Maximum VM number” 355 indicates the maximum number of the VMs 12a and 12b that operate in the group. An entry under “Condition” 356 indicates the condition for activating or deactivating the VM 12a or 12b. An entry under “Processing” 357 indicates the processing to be performed when “Condition” 356 is satisfied.

FIG. 6B illustrates an example of VM access information in FIG. 5.

In FIG. 6B, the VM access information 306 indicates the amounts of access from the VMs 12a and 12b to the virtual disks 14a and 14b in FIG. 3. The VM access information 306 includes entries under “Server” 361, “VM” 362, “Time point” 363, “Read amount” 364 and “Write amount” 365. An entry under “Server” 361 indicates the name of the server 11 in which the VM 12a and 12b operate. An entry under “VM” 362 indicates the name of the VM 12a or 12b. An entry under “Time point” 363 indicates the time point at which performance information has been recorded. An entry under “Read amount” 364 indicates the amount of data that the VM 12a or 12b has read from the virtual disk 14a or 14b. An entry under “Write amount” 365 indicates the amount of data that the VM 12a or 12b has written to the virtual disk 14a or 14b.

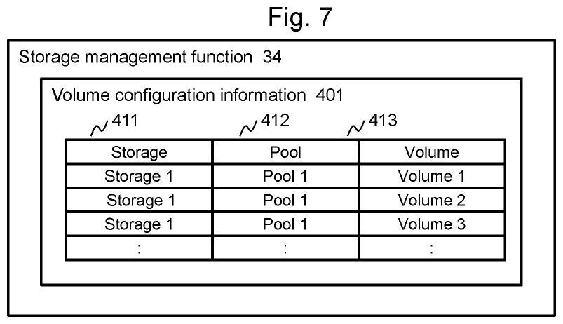

FIG. 7 illustrates an example of information held in the storage management function in FIG. 3.

In FIG. 7, the storage management function 34 manages the storage 21 in FIG. 3. The storage management function 34 includes volume configuration information 401. The volume configuration information 401 holds configuration information about the volume 23. The volume configuration information 401 includes entries under “Storage” 411, “Pool” 412, and “Volume” 413. An entry under “Storage” 411 indicates the name of the storage 21 in which the volume 23 is deployed. An entry under “Pool” 412 indicates the name of the pool 22a or 22b in which the volume 23 is deployed. An entry under “Volume” 413 indicates the name of the volume 23.

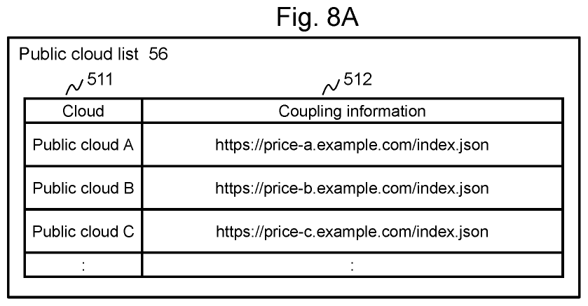

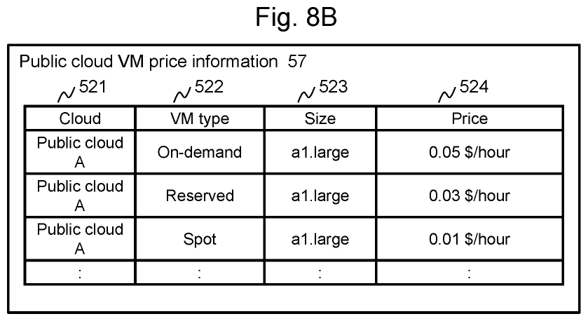

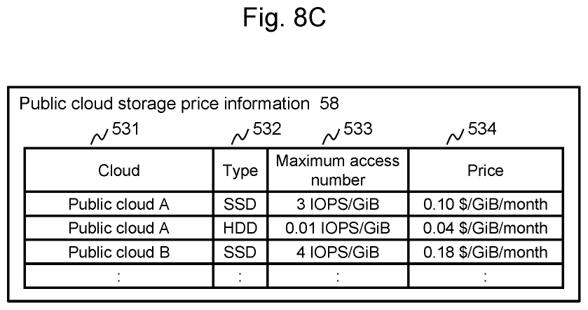

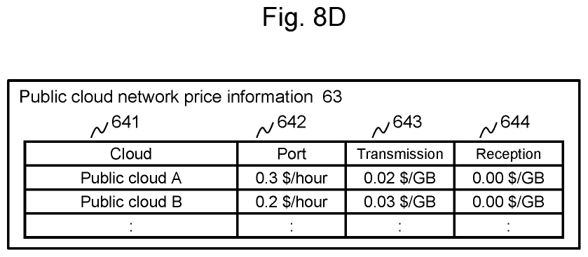

FIG. 8A illustrates an example of the public cloud list in FIG. 3.

In FIG. 8A, the public cloud list 56 is a list of the public clouds M3, on which the VM 41 and the virtual disk 42 are deployed, in FIG. 3. The public cloud list 56 includes entries under “Cloud” 511 and “Coupling information” 512. An entry under “Cloud” 511 indicates the name of the public cloud M3. An entry under “Coupling information” 512 indicates the information about a coupling destination for acquiring information about the public cloud M3. For example, the information about the coupling destination can be represented by a URL (Uniform Resource Locator).

FIG. 8B illustrates an example of the public cloud VM price information in FIG. 3.

In FIG. 8B, the public cloud VM price information 57 indicates a cost incurring when the VM 41 on the public cloud M3 in FIG. 3 is used. The public cloud VM price information 57 includes entries under “Cloud” 521, “VM type” 522, “Size” 523, and “Price” 524 and indicates a price corresponding to the public cloud M3 indicated under “Cloud” 521.

An entry under “VM type” 522 indicates the type of the VM 41. When an entry under “VM type” 522 indicates “On-demand”, the price of the VM 41 is charged only for the time period in which the VM 41 is in operation. When an entry under “VM type” 522 indicates “Reserved”, the price of the VM 41 is charged based on a long-term contract, regardless of the power state of the VM 41. When an entry under “VM type” 522 indicates “Spot”, the price of the VM 41 is charged under a condition that, when the price of the VM 41, which varies in accordance with its demand, falls below a pre-set price, the VM becomes available, and when the price of the VM 41 exceeds a pre-set price, the VM is forcibly deactivated. An entry under “Size” 523 indicates the size of the VM 41. An entry under “Price” 524 indicates the price of the VM 41.

FIG. 8C illustrates an example of the public cloud storage price information in FIG. 3.

In FIG. 8C, the public cloud storage price information 58 indicates a cost incurring when the virtual disk 42 on the public cloud M3 in FIG. 3 is used. The public cloud storage price information 58 includes entries under “Cloud” 531, “Type” 532, “Maximum access number” 533, and “Price” 534 and indicates a price corresponding to the public cloud M3 indicated under the cloud 531. An entry under “Type” 532 indicates the type of the virtual disk 42. An entry under “Maximum access number” 533 indicates the maximum access number per capacity. An entry under “Price” 534 indicates a price per capacity of the virtual disk 42.

FIG. 8D illustrates an example of the public cloud network price information in FIG. 3.

In FIG. 8D, the public cloud network price information 63 indicates a cost incurring when the individual public cloud M3 is coupled to the private cloud M2. The public cloud network price information 63 includes entries under “Cloud” 641, “Port” 642, “Transmission” 643, and “Reception” 644. An entry under “Port” 642 indicates the cost of a port used to couple the public cloud M3 to the private cloud M2. An entry under “Transmission” 643 indicates the cost incurring when the VM 41 on the public cloud M3 transmits data to the private cloud M2. An entry under “Reception” 644 indicates the cost incurring when the VM 41 on the public cloud M3 receives data from the private cloud M2.

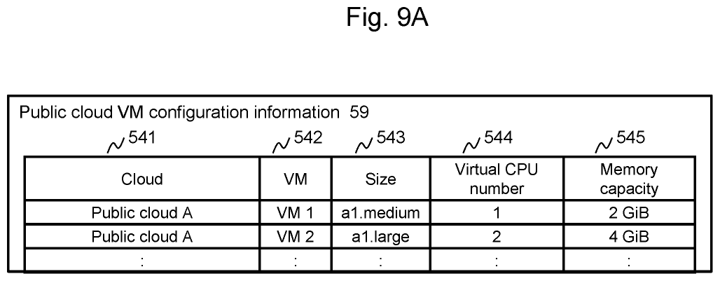

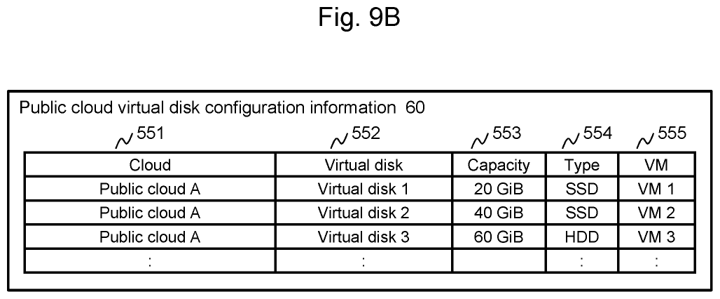

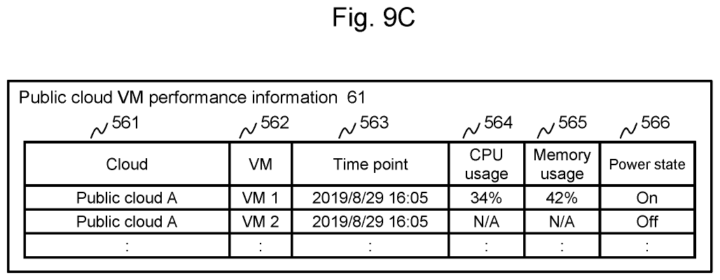

FIG. 9A illustrates an example of the public cloud VM configuration information in FIG. 3.

In FIG. 9A, the public cloud VM configuration information 59 indicates a configuration of the VM 41 in FIG. 3. The public cloud VM configuration information 59 includes entries under “Cloud” 541, “VM” 542, “Size” 543, “Virtual CPU number” 544, and “Memory capacity” 545. An entry under “Cloud” 541 indicates the name of the cloud in which the VM 41 is deployed. An entry under “VM” 542 indicates the name of the VM 41. An entry under “Size” 543 indicates the size of the VM 41. An entry under “Virtual CPU number” 544 indicates the number of virtual CPUs allocated to the VM 41. An entry under “Memory capacity” 545 indicates the memory capacity allocated to the VM 41.

FIG. 9B illustrates an example of the public cloud virtual disk configuration information in FIG. 3.

In FIG. 9B, the public cloud virtual disk configuration information 60 indicates a configuration of the virtual disk 42 in FIG. 3. The public cloud virtual disk configuration information 60 includes entries under “Cloud” 551, “Virtual disk” 552, “Capacity” 553, “Type” 554, and “VM” 555. An entry under “Cloud” 551 indicates the name of the cloud on which the virtual disk 42 is deployed. An entry under “Virtual disk” 552 indicates the name of the virtual disk 42. An entry under “Capacity” 553 indicates the capacity of the virtual disk 42. An entry under “Type” 554 indicates the type of the virtual disk 42. An entry under “VM” 555 indicates the name of the VM 41 that uses the virtual disk 42.

FIG. 9C illustrates an example of the public cloud VM performance information in FIG. 3.

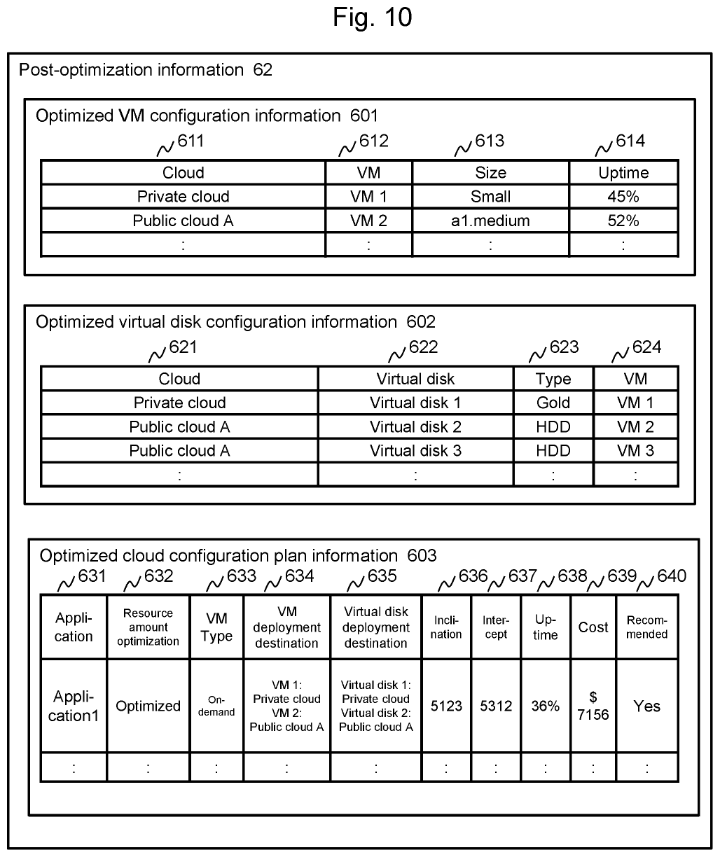

In FIG. 9C, the public cloud VM performance information 61 holds past performance information about the VM 41 in FIG. 3. The public cloud VM performance information 61 includes entries under “Cloud” 561, “VM” 562, “Time point” 563, “CPU usage” 564, “Memory usage” 565, and “Power state” 566. An entry under “Cloud” 561 indicates the name of the cloud on which the VM 41 is deployed. An entry under “VM” 562 indicates the name of the VM 41. An entry under “Time point” 563 indicates the time point at which each performance information has been recorded. An entry under “CPU usage” 564 indicates the CPU usage of the VM 41. An entry under “Memory usage” 565 indicates the memory usage of the VM 41. An entry under “Power state” 566 indicates the power state of the VM 41. The power state is either “On” or “Off”. FIG. 10 illustrates an example of the post-optimization information in FIG. 3.

In FIG. 10, the post-optimization information 62 holds calculation results of the VM size optimization function 53 and the cloud optimization function 54 in FIG. 3. The post-optimization information 62 includes entries under “Optimized VM configuration information” 601, “Optimized virtual disk configuration information” 602, and “Optimized cloud configuration plan information” 603.

The optimized VM configuration information 601 is configuration information about the VM 12a, 12b, or 41 whose size has been optimized. The optimized VM configuration information 601 includes entries under “Cloud” 611, “VM” 612, “Size” 613, and “Uptime” 614. An entry under “Cloud” 611 indicates the name of the cloud on which the VM 12a, 12b, or 41 is deployed. An entry under “VM” 612 indicates the name of the VM 12a, 12b, or 41. An entry under “Size” 613 indicates the size of the optimized VM 12a, 12b, or 41. An entry under “Uptime” 614 indicates the uptime of the VM 12a, 12b, or 41. The uptime has been calculated assuming that the VMs 12a, 12b, and 41 have been optimized.

The optimized virtual disk configuration information 602 is configuration information about the virtual disk 14a, 14b, or 42 whose type has been optimized. The optimized virtual disk configuration information 602 includes entries under “Cloud” 621, “Virtual disk” 622, “Type” 623, and “VM” 624. An entry under “Cloud” 621 indicates the name of the cloud on which the virtual disk 14a, 14b, or 42 is deployed. An entry under “Virtual disk” 622 indicates the name of the virtual disk 14a, 14b, or 42. An entry under “Type” 623 indicates the type of the virtual disk 14a, 14b, or 42 that has been optimized. An entry under “VM” 624 indicates the name of the VM 12a, 12b, or 41 that uses the virtual disk 14a, 14b, or 42.

The optimized cloud configuration plan information 603 is configuration plans that are calculated by the cloud optimization function 54. In each of the configuration plans, the deployment destinations of the VMs 12a, 12b, and 41 and the virtual disks 14a, 14b, and 42 are changed. The optimized cloud configuration plan information 603 includes entries under “Application” 631, “Resource amount optimization” 632, “VM type” 633, “VM deployment destination” 634, “Virtual disk deployment destination” 635, “Inclination” 636, “Intercept” 637, “Uptime” 638, “Cost” 639, and “Recommended” 640. An entry under “Application” 631 indicates the name of the application that represents a configuration. An entry under “Resource amount optimization” 632 indicates whether the amounts of the resources of the VMs 12a, 12b, and 41 have been optimized. An entry under “VM type” 633 indicates the type of the VM 12a, 12b, or 41. An entry under “VM deployment destination” 634 indicates the deployment destination cloud that corresponds to each of the VMs 12a, 12b, and 41. An entry under “Virtual disk deployment destination” 635 indicates the deployment destination cloud that corresponds to each of the virtual disks 14a, 14b, and 42. An entry under “Inclination” 636 indicates the inclination of the line graphs 123A and 123B. An entry under “Intercept” 637 indicates the intercept of the line graphs 123A and 123B. An entry under “Uptime” 638 indicates the average uptime of the application. An entry under “Cost” 639 indicates the cost of the application after the configuration has been changed. An entry under “Recommended” 640 indicates whether the configuration plan is a recommended configuration.

The cloud optimization function 54 generates the optimized cloud configuration plan information 603 per application for each configuration obtained by combining the VM type, the migration destination cloud, the VM deployment destination, and the virtual disk deployment destination. Finally, for example, as in FIG. 1, the line graph 123A is displayed in accordance with the inclination 636 and the intercept 637 of the optimized cloud configuration plan information 603 in FIG. 10 per application, and the circles 124A and 125A are displayed in accordance with the uptime 638 of the optimized cloud configuration plan information 603 per application, on the GUI 101.

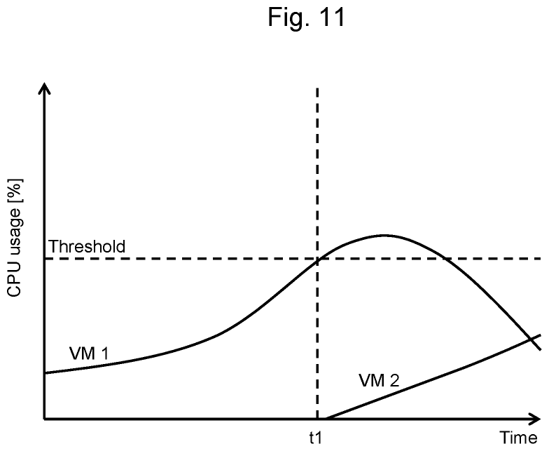

FIG. 11 illustrates an example of a change in the CPU usage when the auto scaling is applied.

In FIG. 11, it is assumed that the CPU usage of a VM 1 has increased due to a load increase and exceeded a threshold at time point t1. At this point, a VM 2 is activated, and as a result, the load on the VM 1 is reduced.

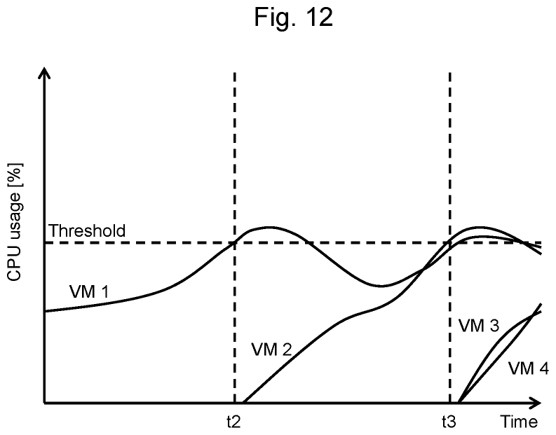

FIG. 12 illustrates an example of a change in the CPU usage in a case where the VM size has been optimized. The load in the example in FIG. 12 is assumed to be the same as that in the example in FIG. 11.

In FIG. 12, the CPU usage of a VM 1 is high since the number of virtual CPUs thereof has been reduced. Therefore, the CPU usage of the VM 1 exceeds the threshold at time point t2, which is earlier than the case in FIG. 11, and a VM 2 is activated. At this point, while the load on the VM 1 is reduced, with the increase in the load on the VM 2, the CPU usage of the VM 1 and VM 2 exceeds the threshold at time point t3. Thus, VMs 3 and 4 are activated, and the load on the VMs 1 and 2 is reduced.

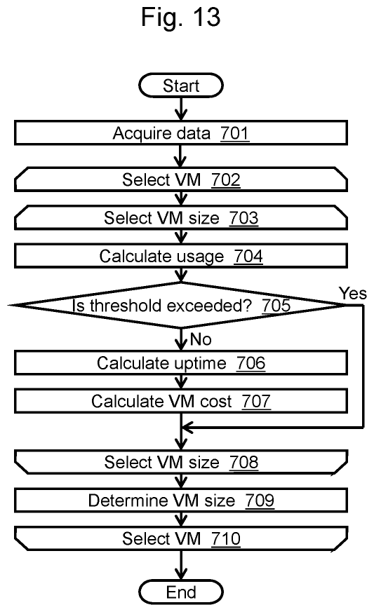

FIG. 13 is a flowchart illustrating processing of the VM size optimization function in FIG. 3.

In FIG. 13, the VM size optimization function 53 optimizes the size of the VM and the type of the storage used by an application that is previously determined to be optimized. This processing is performed, for example, once a day.

In processing 701, the information acquisition function 51 in FIG. 3 acquires information from the private clouds M2 and the public clouds M3 and stores the acquired information in the database 52. Data acquired from the individual private cloud M2 is data in the configuration information database 32, the VM management function 33, and the storage management function 34. Data acquired from the individual public cloud M3 is the public cloud VM price information 57, the public cloud storage price information 58, the public cloud VM configuration information 59, the public cloud virtual disk configuration information 60, and the public cloud VM performance information 61. The information acquisition function 51 accesses the public cloud M3 based on the coupling information 512 in FIG. 8A and acquires data therefrom.

Next, in iteration 702, the VM size optimization function 53 selects a VM used by the application that is previously determined to be optimized from the application information 201 in FIG. 4.

Next, in iteration 703, the VM size optimization function 53 selects a size of the VM from the VM price information 203 in FIG. 4 or the public cloud VM price information 57 in FIG. 8B.

Next, in processing 704, the VM size optimization function 53 calculates CPU usage and memory usage for a case in which the size of the VM selected in the iteration 702 is changed to the size selected in the iteration 703, based on the following formulas (1) and (2), respectively.

CPU usage after the change=CPU usage before the change×Virtual CPU number before the change+Virtual CPU number after the change (1)

Memory usage after the change=Memory usage before the change×Memory capacity before the change÷Memory capacity after the change (2)

Next, in determination 705, the VM size optimization function 53 determines whether the CPU usage after the change and the memory usage after the change that have been calculated in processing 704 exceed respective predetermined thresholds. If the thresholds are exceeded, the processing proceeds to iteration 708. If the thresholds are not exceeded, the processing proceeds to processing 706.

In processing 706, the VM size optimization function 53 calculates VM uptime. To obtain the VM uptime, the VM size optimization function 53 calculates CPU usage after the change based on the following formula (3).

CPU usage after the change=Sum of CPU usage before the change of all the VMs×Virtual CPU number before the change÷Virtual CPU number after the change÷VM number (3)

If this CPU usage after the change satisfies the condition defined in the condition 356 in FIG. 6A, the VM size optimization function 53 performs the processing defined in the processing 357, simulates the activation and deactivation of the VMs, calculates activation time point and deactivation time point of the individual VMs as illustrated in FIG. 12, and calculates the VM uptime.

Next, in processing 707, the VM size optimization function 53 calculates a cost of the individual VM based on the size and the uptime thereof, the VM price information 203 in FIG. 4, and the public cloud VM price information 57 in FIG. 8B.

Next, in iteration 708, if the VM size optimization function 53 has processed all the VM sizes, the processing proceeds to processing 709. If not, the processing proceeds to iteration 703.

Next, in processing 709, the VM size optimization function 53 records the least expensive configuration and uptime among the VM costs calculated in processing 707 in the optimized VM configuration information 601 in FIG. 10.

Next, in iteration 710, if the VM size optimization function 53 has processed all the VMs, the processing ends. If not, the processing proceeds to iteration 702.

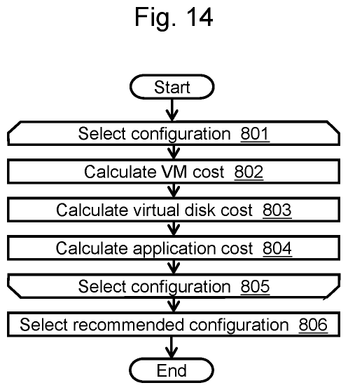

FIG. 14 is a flowchart illustrating processing by the cloud optimization function in FIG. 3.

In FIG. 14, the cloud optimization function 54 optimizes the clouds in which the VMs 12a, 12b, and 41 and the virtual disks 14a, 14b, and 42 in FIG. 3 are deployed. This processing is performed after the processing in FIG. 13 has been performed.

In iteration 801, the cloud optimization function 54 selects a configuration of the VMs and the virtual disks, which will be a basis of the calculation of the VM cost and the virtual disk cost. The cost is calculated for this configuration which is a combination of (S1) resource amount optimization, (S2) cloud-to-cloud migration, (S3) VM type, (S4) migration destination candidate cloud, (S5) VM deployment destination, and (S6) data deployment destination.

In (S1), the cost of a configuration is calculated for each of the case in which the resource amount is optimized and the case in which the resource amount is not optimized. In (S2), the cost of a configuration is calculated for each of the case in which the cloud-to-cloud migration is performed on the VMs and virtual disks and the case in which the cloud-to-cloud migration is not performed. In (S3), when the VMs are deployed on the public cloud, the cost of changing the VM type is calculated for each of the cases in which the VM type is changed to “On-demand”, “Reserved”, and “Spot”. In (S4), when the cloud-to-cloud migration is performed, the cost of the migration is calculated for each of the migration candidate clouds, which are combinations of the private cloud and the public clouds listed in the public cloud list 56 in FIG. 8A. In (S5), the cost is calculated for each of the case in which all the VMs are deployed on the private cloud, the case in which the VMs are deployed on both the private cloud and the public cloud, and the case in which all the VMs are deployed on the public cloud. In (S6), the cost is calculated for each of the case in which all the virtual disks are deployed on the private cloud, the case in which the virtual disks are deployed on both the private cloud and the public cloud, the case in which all the virtual disks are deployed on the public cloud, and the case in which the virtual disks are deployed on the same cloud as that on which the VMs using the virtual disks are deployed. The cloud optimization function 54 selects one configuration from among the combinations of (S1) to (S6) described above.

Next, in processing 802, the cloud optimization function 54 calculates costs of all the VMs used by the application that is previously determined to be optimized among the applications in the application information 201 in FIG. 4. In a case of the VM on the private cloud, if the resource amount thereof has been optimized, the cost is calculated based on the VM size that has been determined in processing 709 in FIG. 13 and the VM price information 203. If the resource amount of the VM is not optimized, the cost is calculated based on the VM configuration information 301 in FIG. 5 and the VM price information 203 in FIG. 4.

In a case of the VM on the public cloud, if the resource amount thereof has been optimized, the cost is calculated by referring to the VM type based on the VM size determined in processing 709 and the public cloud VM price information 57 in FIG. 8B. If the resource amount of the VM is not optimized, the cost is calculated by referring to the VM type based on the public cloud VM configuration information 59 in FIG. 9A and the public cloud VM price information 57 in FIG. 8B. When the cloud-to-cloud migration is performed, in terms of the virtual CPU number and the memory capacity, the VM size equal to or more than the size of the VM used before the migration is applied, and the VM size having the lowest price is applied. In a case in which the migration destination of the VMs includes both the private cloud and the public cloud, the cost of the individual VM is calculated for each of the case in which the VM is deployed on the private cloud and the case in which the VM is deployed on the public cloud, and the cloud with the lower cost is selected to be the migration destination.

Next, in processing 803, the cloud optimization function 54 calculates a cost of the virtual disk used by each VM whose cost has been calculated in processing 802. In a case of the virtual disk on the private cloud, by using the virtual disk configuration information 302 in FIG. 5, the cloud optimization function 54 specifies the virtual disk used by the corresponding VM and acquires the corresponding data store and capacity of the virtual disk. In addition, the cloud optimization function 54 specifies the volume that constitutes the data store by using the data store configuration information 303 in FIG. 5. In addition, the cloud optimization function 54 specifies the pool corresponding to the volume by using the volume configuration information 401 in FIG. 7. In addition, the cloud optimization function 54 specifies the tier corresponding to the pool by using the tier configuration information 202 in FIG. 4. The cloud optimization function 54 then calculates the cost of the virtual disk based on the capacity of the virtual disk, the tier in which the virtual disk is deployed, and the storage price information 204.

In a case of the virtual disk on the public cloud, by using the public cloud virtual disk configuration information 60 in FIG. 9B, the cloud optimization function 54 specifies the virtual disk used by the corresponding VM and acquires the corresponding capacity and type of the virtual disk. The cloud optimization function 54 then calculates the cost of the virtual disk based on the capacity and the type of the virtual disk and the public cloud storage price information 58 in FIG. 8C.

In the present embodiment, the case in which the virtual disks are migrated is described. However, if the volume is directly mounted on the VM, the volumes may be migrated. In this case, the costs of the volumes are calculated. In processing 803, in a case in which the VMs and the virtual disks are deployed on different clouds, the cloud optimization function 54 calculates a network cost that is incurring when the VMs access the virtual disks. To calculate the network cost, the cloud optimization function 54 calculates a total read amount and a total write amount for an analysis period from the read amounts and the write amounts in the VM access information 306 in FIG. 6B, calculates costs incurring for transmission and reception by using the public cloud network price information 63 in FIG. 8D, and obtains the network cost by adding a port usage fee to the transmission cost and the reception cost.

Next, in processing 804, the cloud optimization function 54 stores the calculation results obtained in processing 802 and 803 in the optimized cloud configuration plan information 603 in FIG. 10. The inclination 636 is a price per one percent of the uptime of the VM whose VM type is on-demand. Since the VMs having different costs coexist, a weighted average of the VM cost and the VM number is calculated based on formula (4) below.

Inclination=Σ(VM cost×VM number)÷VM number (4)

The uptime 638 is average uptime of the VMs in the corresponding application. Since the costs are different per VM, a weighted average of the uptime of each VM and the VM cost is calculated based on formula (5) below.

Average uptime of VMs in application=Σ(VM uptime×VM cost)÷Σ(VM cost) (5)

The intercept 637 is a sum of the costs of the VMs whose VM type is reserved or spot and the costs of the virtual disks. The cost 639 of the VMs and the virtual disks in the application is calculated by formula (6) below.

Cost=Inclination×Uptime+Intercept (6)

Next, in iteration 805, if the cloud optimization function 54 has processed all the configurations, the processing proceeds to processing 806. If not, the processing proceeds to iteration 801.

In processing 806, the cloud optimization function 54 selects a recommended configuration. An entry “Yes” is indicated under “Recommended” 640 included in a configuration that minimizes the cost incurring when the VMs and the virtual disks are deployed only on the private cloud and a configuration that minimizes the cost incurring when the VMs and the virtual disks are deployed on each public cloud, and an entry “No” is indicated under “Recommended” 640 in the other configurations. The configurations whose “Recommended” 640 indicates “Yes” are displayed when the options are not displayed, as illustrated in FIG. 1. The configurations whose “Recommended” 640 indicates “No” are displayed when the options are displayed, as illustrated in FIG. 2.

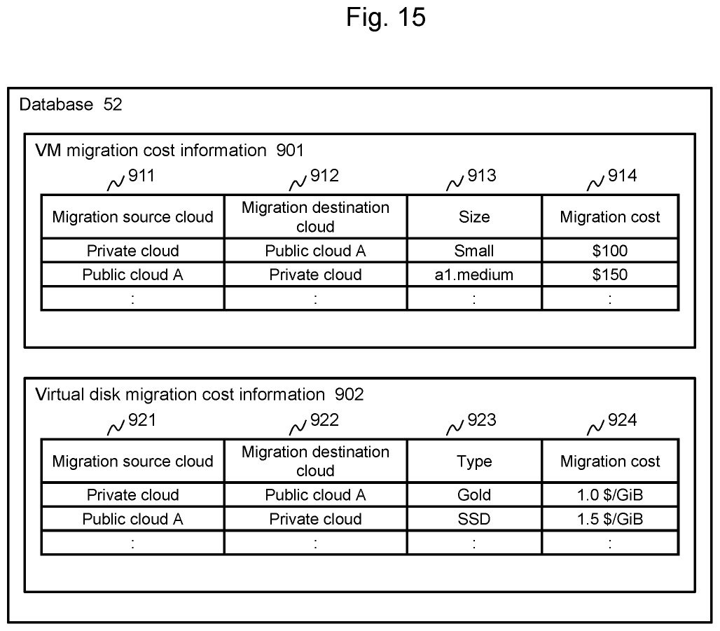

FIG. 15 illustrates examples of the VM migration cost information and the virtual disk migration cost information stored in the database in FIG. 3. These items of information are determined in advance.

In FIG. 15, VM migration cost information 901 indicates a cost incurring when the VM is migrated. The VM migration cost information 901 includes entries under “Migration source cloud” 911, “Migration destination cloud” 912, “Size” 913, and “Migration cost” 914. An entry under “Migration source cloud” 911 indicates the name of the cloud that is a migration source of the VM. An entry under “Migration destination cloud” 912 indicates the name of the cloud that is a migration destination of the VM. An entry under “Size” 913 indicates the size of the VM to be migrated. An entry under “Migration cost” 914 indicates the cost needed for the migration.

Virtual disk migration cost information 902 indicates a cost incurring when the virtual disk is migrated. The virtual disk migration cost information 902 includes entries under “Migration source cloud” 921, “Migration destination cloud” 922, “Type” 923, and “Migration cost” 924. An entry under “Migration source cloud” 921 indicates the name of the cloud that is a migration source of the virtual disk. An entry under “Migration destination cloud” 922 indicates the name of the cloud that is a migration destination of the virtual disk. An entry under “Type” 923 indicates the tier of the type of the virtual disk to be migrated. An entry under “Migration cost” 924 indicates the cost needed for the migration.

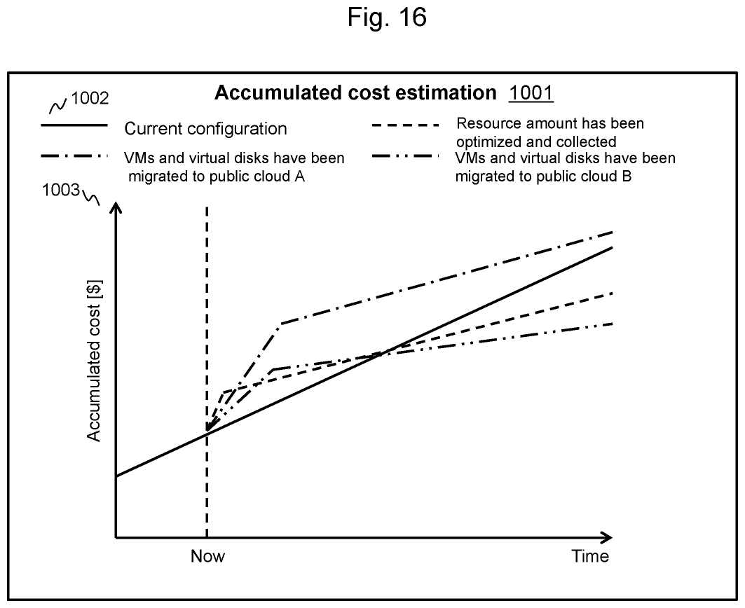

FIG. 16 illustrates an example of accumulated cost estimation presented on the cost presentation apparatus according to the embodiment.

In FIG. 16, the multi-cloud management system M4 in FIG. 3 refers to the optimized cloud configuration plan information 603 in FIG. 10 and the VM migration cost information 901 and the virtual disk migration cost information 902 in FIG. 15 and estimates an accumulated cost obtained by adding the migration cost 914 indicated in the VM migration cost information 901 and the migration cost 924 indicated in the virtual disk migration cost information 902 to the cost 639 indicated in the optimized cloud configuration plan information 603. The multi-cloud management system M4 can then display an accumulated cost estimation 1001 that indicates the estimation result of the accumulated cost on the GUI 101.

The accumulated cost estimation 1001 indicates a change in the accumulated cost from the past to the future including the cases of the optimization of the VM size and the optimization of the cloud configuration. The accumulated cost estimation 1001 includes legends 1002 and a line graph 1003. Each of the legends 1002 indicates a configuration at the time when the cost is calculated. The line graph 1003 indicates a change in the accumulated cost for each configuration.

When the cloud-to-cloud migration is performed, the migration costs 914 and 924 are temporarily incurring. However, if the cloud-to-cloud migration is performed, the cost 639 will be accumulated so that the accumulated cost could eventually reverse the accumulated cost of the current configuration. Therefore, by displaying the accumulated cost estimation 1001 on the GUI 101, the multi-cloud management system M4 can provide the user with the information for determining whether to execute the cloud-to-cloud migration even if the migration cost is incurring.

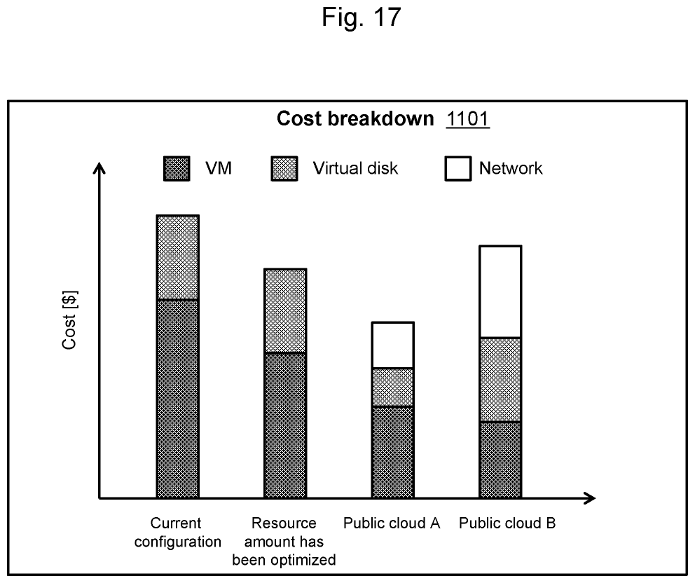

FIG. 17 illustrates an example of the cost breakdown presented by the cost presentation apparatus according to the embodiment.

In FIG. 17, cost breakdown 1101 indicates the breakdown of the cost of each configuration. The breakdown includes the VM cost, the virtual disk cost, and the network cost. The multi-cloud management system M4 displays the cost breakdown 1101 on the GUI 101 per configuration obtained by combining the VM type, the migration destination cloud, the VM deployment destination, and the virtual disk deployment destination. Thus, the user can grasp the breakdown of the cost of each configuration when the cloud-to-cloud migration is performed.

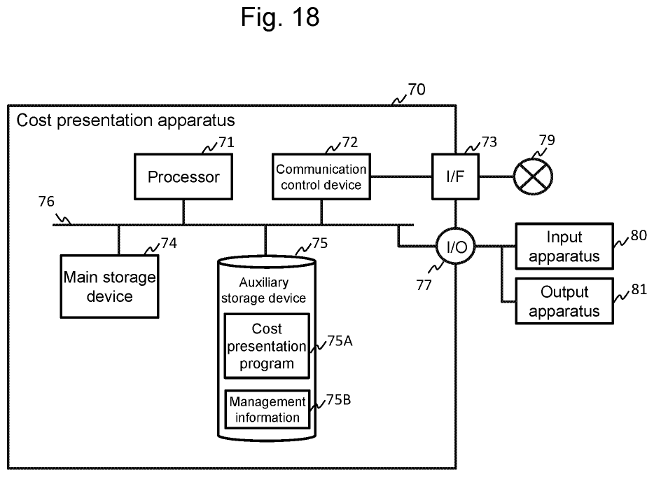

FIG. 18 is a block diagram illustrating an example of a hardware configuration of the cost presentation apparatus according to the embodiment.

In FIG. 18, the cost presentation apparatus 70 includes a processor 71, a communication control device 72, a communication interface 73, a main storage device 74, an auxiliary storage device 75, and an input-output interface 77. The processor 71, the communication control device 72, the communication interface 73, the main storage device 74, the auxiliary storage device 75, and the input-output interface 77 are coupled to each other via an internal bus 76. The main storage device 74 and the auxiliary storage device 75 are accessible from the processor 71.

An input apparatus 80 and an output apparatus 81 are provided outside the cost presentation apparatus 70. The input apparatus 80 and the output apparatus 81 are coupled to the internal bus 76 via the input-output interface 77. The input apparatus 80 is, for example, a keyboard, a mouse, a touch panel, a card reader, or an audio input apparatus. The output apparatus 81 is, for example, a screen display apparatus (a liquid crystal monitor, an organic EL (Electro Luminescence) display, a graphic card, or the like), an audio output apparatus (a speaker, or the like), or a printing apparatus.

The processor 71 is hardware that controls the entire operation of the cost presentation apparatus 70. The processor 71 may be a CPU (Central Processing Unit) or a GPU (Graphics Processing Unit). The processor 71 may be a single-core processor or a multi-core processor. The processor 71 may include a hardware circuit (for example, an FPGA (Field-Programmable Gate Array) or an ASIC (Application Specific Integrated Circuit)) that performs a part of or entire processing thereof. The processor 71 may include a neural network.

The main storage device 74 can be configured with, for example, a semiconductor memory such as an SRAM or a DRAM. The main storage device 74 can store a program being executed by the processor 71 and provide a work area for the processor 71 to execute a program.

The auxiliary storage device 75 is a storage device that has a large storage capacity, such as a hard disk device or an SSD (Solid State Drive). The auxiliary storage device 75 can hold execution files of various programs and data used for executing programs. The auxiliary storage device 75 can store a cost presentation program 75A and management information 75B. The cost presentation program 75A may be software that is installable in the cost presentation apparatus 70 or may be implemented in the cost presentation apparatus 70 as firmware. The management information 75B is various kinds of information stored in the database 52 in FIG. 3.

The communication control device 72 is hardware that has functions of controlling communication with the outside. The communication control device 72 is coupled to a network 79 via the communication interface 73. The network 79 may be a WAN (Wide Area Network) such as the Internet or a LAN (Local Area Network) such as Wi-Fi or Ethernet (registered trademark). Alternatively, the WAN and the LAN may coexist.

The input-output interface 77 converts data inputted from the input apparatus 80 into a data format that can be processed by the processor 71 and converts data outputted from the processor 71 into a data format that can be processed by the output apparatus 81.

By causing the processor 71 to read the cost presentation program 75A onto the main storage device 74 and execute the cost presentation program 75A, the cost of the VMs and the virtual disks needed after the IT system has been migrated between clouds can be calculated for each configuration obtained by combining the VM type, the migration destination cloud, the VM deployment destination, and the virtual disk deployment destination, and a relationship between the cost of the VMs and the virtual disks in each of the configurations and activation time of the VMs as well as the activation time of the VMs in the configuration can be displayed on the GUI.

Alternatively, a plurality of processors and computers may share the execution of the cost presentation program 75A. Still alternatively, the processor 71 may instruct a cloud computer or the like via the network 79 to entirely or partially execute the cost presentation program 75A and receive the execution results.

The present disclosure is not limited to the embodiment described above and includes various modifications. For example, the above embodiment has been described in detail to facilitate understanding of the present disclosure, and the present disclosure is not necessarily limited to the configuration having all the constituent elements described above. In addition, part of the configuration in one embodiment may be replaced by the configuration of another embodiment, or the configuration of one embodiment may be added to the configuration of another embodiment. Further, part of the configuration of one embodiment may be added to, deleted from, or replaced by the configuration of another embodiment. Furthermore, the above configurations, functions, processing units, and the like may be partially or entirely realized as hardware, for example, by designing an integrated circuit.

What is claimed is:

1. A cost presentation apparatus for presenting a cost incurring when an IT (Information Technology) system is migrated between clouds, the cost presentation apparatus comprising:
a memory configured to store management information and a presentation program; and
a processor configured to execute the cost presentation program by referring to the management information, wherein
the management information enables estimation of a relationship between a cost of an infrastructure resource incurring when the IT system is migrated between clouds and activation time of the infrastructure resource and estimation of the activation time of the infrastructure resource,
the processor estimates a relationship between the cost of the infrastructure resource incurring after the IT system has been migrated between clouds and the activation time of the infrastructure resource and estimates the activation time of the infrastructure resource, and
the processor presents a result of the estimation of the relationship between the cost of the infrastructure resource and the activation time of the infrastructure resource, and of the estimation of the activation time of the infrastructure resource.

2. The cost presentation apparatus according to claim 1, wherein
the processor displays, on a screen of an output apparatus, the relationship between the cost of the infrastructure resource incurring before the IT system is migrated between clouds and the activation time of the infrastructure resource, and the activation time of the infrastructure resource, and
the processor displays, on the screen of the output apparatus, the relationship between the cost of the infrastructure resource incurring after the IT system has been migrated between clouds and the activation time of the infrastructure resource, and the activation time of the infrastructure resource.

3. The cost presentation apparatus according to claim 1, wherein the processor displays, on a screen of an output apparatus, the relationship between the cost of the infrastructure resource incurring after the IT system has been migrated between clouds and the activation time of the infrastructure resource on a graph indicating the relationship between the cost of the infrastructure resource incurring before the IT system is migrated between clouds and the activation time of the infrastructure resource.

4. The cost presentation apparatus according to claim 1, wherein
the processor estimates a cost of a VM (Virtual Machine) and a virtual disk in each configuration obtained by combining a VM type, a migration destination cloud, a VM deployment destination, and a virtual disk deployment destination, and presents a relationship between the cost of the VM and the virtual disk in each of the configurations and activation time of the VM, and the activation time of the VM in the configuration.

5. The cost presentation apparatus according to claim 4, wherein the processor estimates a relationship between the cost of the infrastructure resource and the activation time of the infrastructure resource assuming that the cost of the VM is proportional to the activation time of the VM and that the cost of the virtual disk is constant.

6. The cost presentation apparatus according to claim 5, wherein the processor estimates activation time of the VM, the size of which has been optimized based on auto scaling.

7. The cost presentation apparatus according to claim 1, wherein, when a plurality of applications, each of which is allocated with the infrastructure resource, exist, the processor estimates, for each of the applications, a relationship between the cost of the infrastructure resource and the activation time of the infrastructure resource, and the activation time of the infrastructure resource.

8. The cost presentation apparatus according to claim 1, wherein the processor estimates an accumulated cost obtained by adding a cost of migrating the infrastructure resource to the cost relating to the activation time of the infrastructure resource and presents a change in the accumulated cost.

9. The cost presentation apparatus according to claim 4, wherein the processor
estimates a total cost obtained by adding a network cost, which is incurring when the infrastructure resource is used, to the cost relating to the activation time of the infrastructure resource, and
presents a result of estimation of a relationship between the infrastructure resource total cost and the activation time of the infrastructure resource, and of estimation of the activation time of the infrastructure resource.

10. The cost presentation apparatus according to claim 9, wherein the processor presents a breakdown of the total cost including costs of the VM, virtual disk, and a network for each configuration obtained by combining the VM type, the migration destination cloud, the VM deployment destination, and the virtual disk deployment destination.

11. A cost presentation method for presenting a cost incurring when an IT (Information Technology) system is migrated between clouds,
the cost presentation method comprising, by a computer including a memory that stores management information which enables estimation of a relationship between a cost of infrastructure resource incurring when the IT system is migrated between clouds and activation time of the infrastructure resource and estimation of the activation time of the infrastructure resource and a cost presentation program, and a processor that executes the cost presentation program by referring to the management information:
estimating a relationship between a cost of an infrastructure resource incurring after the IT system has been migrated between clouds and activation time of the infrastructure resource and estimating the activation time of the infrastructure resource; and
presenting a result of the estimation of the relationship between the cost of the infrastructure resource and the activation time of the infrastructure resource, and of the estimation of the activation time of the infrastructure resource.

12. A storage medium, which is a computer-readable storage medium storing a cost presentation program for presenting a cost incurring when an IT (Information Technology) system is migrated between clouds and for causing a computer to perform:
referring to management information that enables estimation of a relationship between a cost of infrastructure resource incurring when the IT system is migrated between clouds and activation time of the infrastructure resource and estimation of the activation time of the infrastructure resource;
estimating a relationship between the cost of infrastructure resource incurring after the IT system has been migrated between clouds and the activation time of the infrastructure resource and estimating the activation time of the infrastructure resource; and
presenting a result of the estimation of the relationship between the cost of the infrastructure resource and the activation time of the infrastructure resource, and of the estimation of the activation time of the infrastructure resource.
